(19) United States
(12) Patent Application Publication
(10) Pub. No.: US 2005/0264253 A1
(43) Pub. Date: Dec. 1, 2005

(54) Linear power module

(76) Inventor: Mladen Ivankovic, Oakville (CA)

Correspondence Address: WINSTON & STRAWN LLP, 1700 K STREET, N.W., WASHINGTON, DC, 20006, US

(21) Appl. No.: 10/968,351

(22) Filed: Oct. 20, 2004

Related U.S. Application Data
(60) Provisional application No. 60/513,519, filed on Oct. 21, 2003.

(51) Int. Cl. H02P 7/36

(52) U.S. Cl. 318/685

(57) ABSTRACT

The present invention includes a reliable, configurable, compact, and low-cost linear electric motor controller for a vehicular heating ventilating and air conditioning (HVAC) system and methods of control. The controller features multiple input interfaces, specifically an interface for pulse width modulation control; an interface for discrete, stepwise control; and an interface for continuous variable control. The controller is implemented on an application-specific integrated circuit, and voltage to the electric motor is varied by a power metal-oxide semiconductor field-effect transistor (MOSFET).

### CROSS-REFERENCE TO RELATED APPLICATIONS

This application claims the benefit of U.S. Provisional Patent Application No. 60/513,519, filed on Oct. 21, 2003, the entire contents of which is incorporated herein by express reference thereto.

### FIELD OF THE INVENTION

The present invention relates to electric motor controllers, and more specifically to a linear electric motor controller having multiple input interfaces.

### BACKGROUND OF THE INVENTION

The conventional fan speed selector typically used on an automobile is based on a resistor card. Most selectors comprise multiple stages of resistors and relays, and include a multi-position selector switch that allows the operator to set the speed of the fan motor to multiple speeds, e.g., low, medium and high. Such selectors provide only discrete control of the fan motor speed, and do not allow fine-tuning of the fan motor speed to ensure the maximum comfort of the passengers. Furthermore, since finer control of the motor speed requires a greater number of stages of resistors and relays, the cost of the conventional selector increases with the required degree of control of the fan motor speed. Because automobile manufacturing is a mass production industry, automobile manufacturers desire to lower unit costs as much as possible.

In addition, since the resistor card is exposed to the open air when installed inside the dashboard of an automobile, it is subject to corrosion, which negatively impacts the life of the card. Because resistors are made of ceramic materials, environmental heat and vibration of the automobile also negatively impact the life of the resistor card. The replacement of a faulty fan speed selector can be very expensive. For example, although the resistor card may cost only a few tens of dollars, the labor costs to replace the unit can run into hundreds of dollars because the interior of the dashboard is not easily accessible. In addition, the automobile owner is likely to experience the inconvenience of lost time and transportation while service to damaged parts is performed.

Conventional resistor card-based fan motor speed selectors also lack configurability. Namely, a three-position selector cannot be configured to provide four levels of speed control. Thus, automobile manufacturers are required to maintain an inventory of resistor cards for the different gradations of desired control of motors. Automobile manufacturers are also required to maintain an inventory of resistor cards for each different fan motor model to be controlled. The maintenance of multiple inventories of fan speed selectors is a highly undesirable cost to automobile manufacturers.

Conventional resistor-card based fan motor speed selectors also do not maintain a constant motor speed during operation because of changes in ambient temperature or battery voltage.

Although automobile manufacturers have desired a configurable, low-cost fan speed selector that provides continuous (instead of discrete) control, a number of technical hurdles have stood in the way of achieving these objectives. Although fan motor speed selectors have been utilized since before the invention of the transistor in the early 1950s, it is only recently that compact, low-priced power switches, i.e., metal-oxide semiconductor field-effect transistors (MOSFETs), powerful enough to control the fan motor of an automobile have come on the market at an attractive price. Furthermore, cost-effectively integrating the associated signal processing capabilities compactly on a chip and maintaining the constant speed of the fan motor have been problematic.

As an example of a conventional controller, U.S. Pat. No. 5,764,024, “Pulse width modulator (PWM) system with low cost dead time distortion correction,” describes a pulse width modulator (PWM) system (100) that detects several load current conditions to completely correct for the distortion caused by dead time insertion when driving an inverter-fed inductive load, such as a three-phase AC motor. The system includes an inexpensive voltage sensor (140) that senses the output voltage at the end of each successive dead time interval in which neither a pullup transistor (51) nor a pulldown transistor (52) is driving. The system (100) includes a programmable PWM (125), two storage elements (131,132) such as D-type flip flops, and a memory-mapped register (133). The register stores the output of the flip-flops to indicate a near-zero load current condition. When it detects this condition, the system (100) changes the duty cycle of the PWM output signals to yield output voltages and currents that more closely approximate a sine wave. The system (100) is particularly useful as part of a low-cost micro controller (120).

Yet another example is U.S. Pat. No. 5,198,809, “Hard wired programmable controller especially for heating ventilating and air conditioning (HVAC systems),” which describes inputs that are programmably interfaced and interlocked with output so that the state of the outputs and the operation of equipment connected thereto depends on the hierarchy or priority (control strategy) which is programmed into the controller. The inputs may be contacts (switch closures) of switches that are thrown to operate HVAC units and high or low limit sensors such as thermostats and pressure sensors of an HVAC system. The outputs operate the motor controls of motors, which drive the blowers, fans, pumps, dampers, and the like of the HVAC system for environmental control and the safety both of the occupants of a facility and the HVAC equipment therein. The programmable controller has an on-matrix and an off-matrix of switch points, which are arranged in columns and rows. Each row of switch points is connected to an input circuit. The columns of switch points in the on-matrix are connected to the outputs via control logic to which each column of switch points is connected. Each input is connected through control logic, which is capable of reversing the logic state presented by the input so that a normally asserted input (e.g. a normally closed contact of a low limit sensor) is asserted when the contact opens.

### SUMMARY OF THE INVENTION

The present invention seeks to solve one or more of the problems of the prior art controllers. Various suitable embodiments of the invention include one or more of the following advantages:

It is an object of the present invention to provide a more reliable fan speed selector.

It is another object of this invention to provide a configurable fan speed selector.

It is yet another object of this invention to provide a continuously controlled fan speed selector.

It is yet another object of this invention to provide a compact fan speed selector.

It is yet another object of this invention to provide a low-cost fan speed selector.

It is yet another object of this invention to provide a long-life fan speed selector.

It is yet another object of this invention to provide a fan speed selector that maintains a constant motor speed.

It is yet another object of this invention to provide a drop-in replacement fan speed selector that incorporates one or more of the above objects.

### BRIEF DESCRIPTION OF THE DRAWINGS

Further features and advantages of the invention can be ascertained from the following detailed description that is provided in connection with the drawing(s) described below:

FIG. 1 shows a conventional fan speed selector based on a resistor card (prior art);

FIG. 2 shows a linear electric motor controller with multiple input interfaces according to the invention;

FIG. 3 shows a schematic of an input block of a linear electric motor controller with multiple input interfaces according to the invention;

FIG. 3.1.1-1 shows an LPM Blower Motor Controller Context Diagram according to the invention;

FIG. 3.1.2-1 shows an LPM Blower Motor Controller Electrical Interface Definition for PWM or DC control according to the invention;

FIG. 3.1.2-2 shows an LPM Blower Motor Controller Electrical Interface Definition for switch (manual) control according to the invention;

FIGS. 4A and 4B show a typical LPM Blower Motor Controller Transfer Function according to the invention;

FIG. 5 shows a typical mounting footprint for the LPM controller of the invention; and

FIG. 6 shows a typical mounting orientation for the LPM controller of the invention.

### DESCRIPTION OF THE PREFERRED EMBODIMENTS OF THE INVENTION

The present invention relates to electric motor controllers, and more specifically to a linear electric motor controller having multiple input interfaces. In a particular embodiment, the invention relates to a linear power module blower motor controller (herein referred to as the “LPM” or “LPM Controller”).

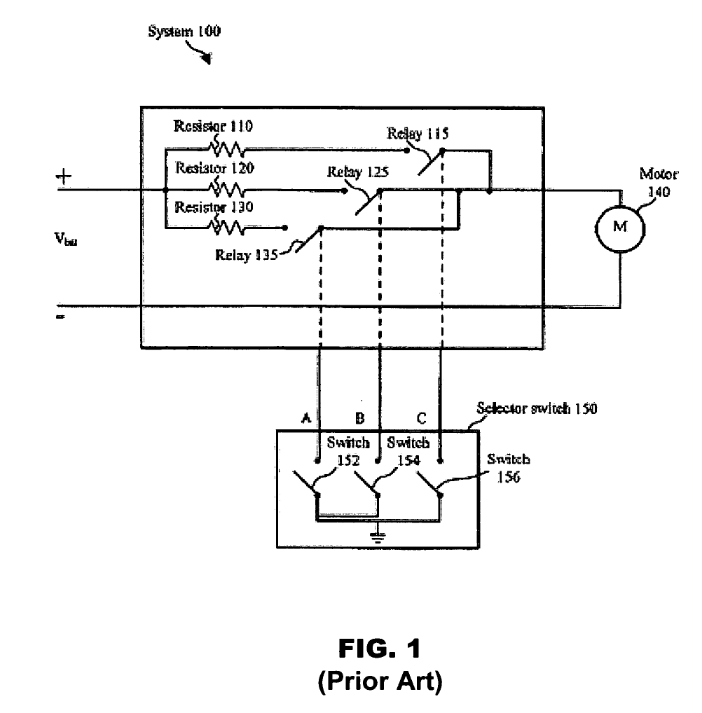

FIG. 1 (prior art) shows a system 100 that is representative of a typical conventional fan speed selector based on a resistor card that is used in an automobile.

System 100 comprises a series of resistors 110, 120, and 130; a series of relays 115, 125, and 135; a motor 140; and a selector switch 150, further including a series of switches 152, 154, and 156, arranged as shown in FIG. 1. The resistance of resistor 110 is greater than the resistance of resistor 120, and the resistance of resistor 120 is greater than that of resistor 130. Switches 152, 154, and 156 correspond to the positions of fan speed selector switch 150, which is typically installed in the dashboard of the automobile.

When relay 115 is activated by the closing of switch 156, resistor 110 is placed in serial connection with motor 140; in this case, since resistor 110 has the greatest resistance of the three resistors 110, 120, and 130, motor 140 operates at low speed. Likewise, when relay 125 is activated by the closing of switch 154, resistor 120 is placed in serial connection with motor 140; in-this case, since resistor 120 has a resistance between that of resistors 110 and 120, motor 140 operates at medium speed. Likewise, when relay 135 is activated by the closing of switch 152, resistor 130 is placed in serial connection with motor 140; in this case, since resistor 130 has the lowest resistance of the three resistors 110, 120, and 130, motor 140 operates at high speed. The three different speeds at which motor 140 operates depend on the resistance values of resistors 110, 120 and 130. Furthermore, selector switch 150 may also be constituted with a fourth switch and a fourth relay that connects power source V_{bat} to motor 140 directly without any resistor in series, in which case motor 140 operates at its highest speed.

In addition, some arrangements of conventional fan speed selectors allow for the activation of more than one relay at a time, which makes possible the selection of motor speeds between the low, medium and high speeds. Such arrangements allow for finer control of the speed of the motor while maintaining compactness of the system by minimizing the number of relays and resistors. However, the fineness of control is still discrete rather than continuous. The arrangement of three stages of resistors, relays, and switch terminals shown in FIG. 1 is depicted to represent a typical conventional fan speed selector system; however, conventional systems are not limited to three stages, and may contain fewer or greater than three stages. The choice of the number of stages is determined by the desired degree of control of motor 140, and by the allocated budget for the system. The cost of the system increases with the number of stages.

System 100 has a disadvantage in that it is not configurable. For example, a three-stage system cannot be configured to provide the functionality of a six-stage system. Instead, a different system must be provided, which requires automobile manufacturers to maintain an inventory of three-stage systems, four-stage systems, and so on. Furthermore, since resistors 110, 120, and 130 are fixed resistors, automobile manufacturers must also maintain an inventory of systems for different fan motor models, which is very costly.

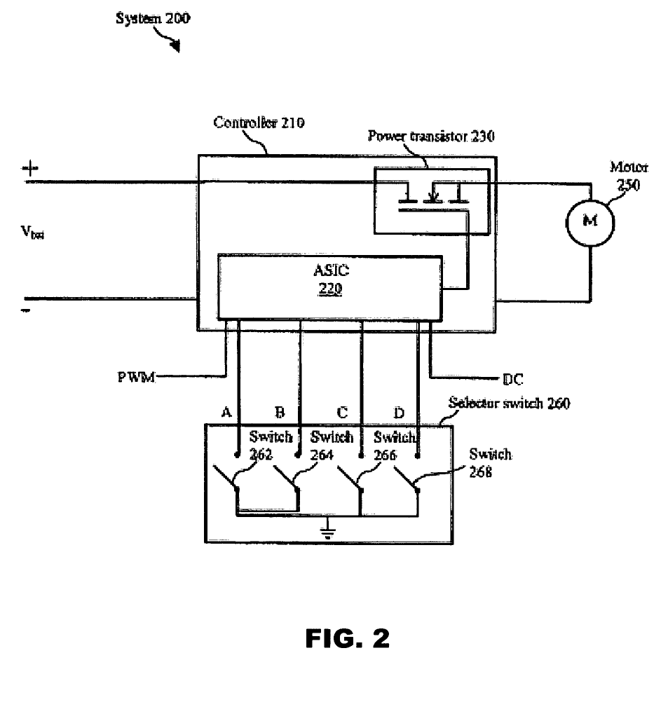

FIG. 2 shows a block diagram of a linear electric motor controller system 200 of the present invention. System 200 comprises a controller 210 further having an application-specific integrated circuit (ASIC) 220 and a power transistor 230. Controller 210 is connected to a power source V_{bat} and a motor 250, for example, the motor of a heating, ventilating, and air conditioning (HVAC) system in an automobile, arranged as shown in FIG. 2. ASIC 220 is connected to a three-stage selector switch 260, further having switches 262, 264, 266, and 268 that correspond to positions A, B, C and D on selector switch 260. ASIC 220 is a linear motor controller integrated circuit as described in co-pending U.S. patent application Ser. No. 10/017,232, filed Dec. 13, 2001 and published as U.S. 2003/0057899, by Carter Group Canada. As described in the '899 publication, ASIC 220 provides linear control of the motor speed through the use of a voltage feedback loop across the motor connections. Thereby, even if the battery voltage varies due to environmental factors such as changes in ambient temperature or the operating condition of the car, the speed of the motor is maintained at a constant. Power transistor 230 is a MOSFET capable of handling, for example, 60 A and 50 V.

Controller 210 emulates the function of a resistor card by controlling the voltage across motor 250 by means of power transistor 230 connected in series with motor 250.

In operation, when the operator selects position A of selector switch 260 by closing switch 262, ASIC 220 detects the grounding of the corresponding pin, and accordingly controls power transistor 230 to produce a predetermined first current that is supplied to motor 250. Thereby, the desired voltage is supplied to motor 250 so as to generate a first desired fan rotation speed. Thus, this operates as an equivalent to the first stage of a resistor card in a conventional fan speed selector.

Likewise, when the operator selects position B of selector switch 260 by closing switch 264, ASIC 220 detects the grounding of the corresponding pin, and accordingly controls power transistor 230 to produce a predetermined second voltage that is supplied to motor 250. Thereby, the desired voltage is supplied to motor 250 so as to generate a second desired fan rotation speed. Thus, this operates as an equivalent to the second stage of a resistor card in a conventional fan speed selector.

The same logic applies to the selection of position C of selector switch 260. Furthermore, selector switch 260 shown in FIG. 2 is not limited to three stages, and may have a fewer or greater number of stages.

ASIC 220 is further connected to a pulse-width modulation (PWM) signal line and a DC signal line to enable pulse-width modulation control and continuously variable control of motor 250, respectively.

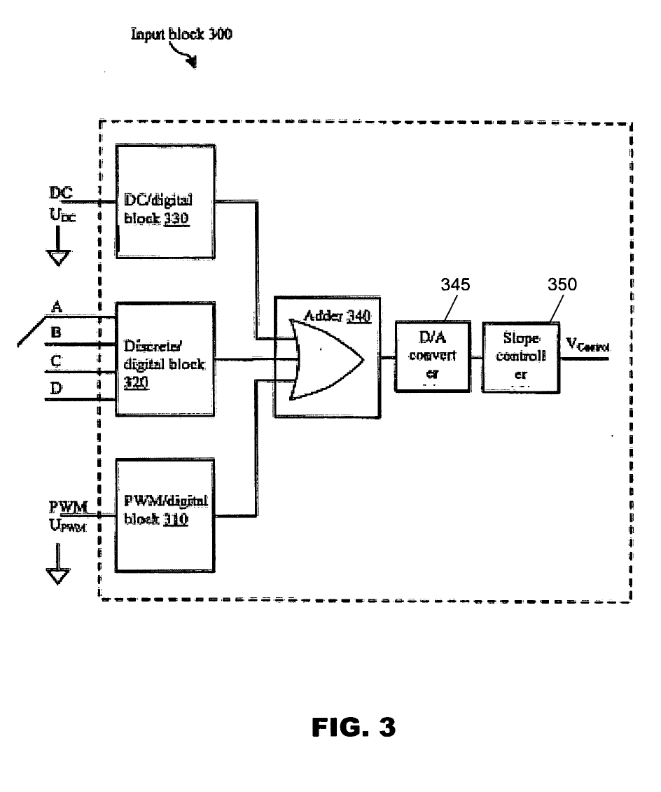

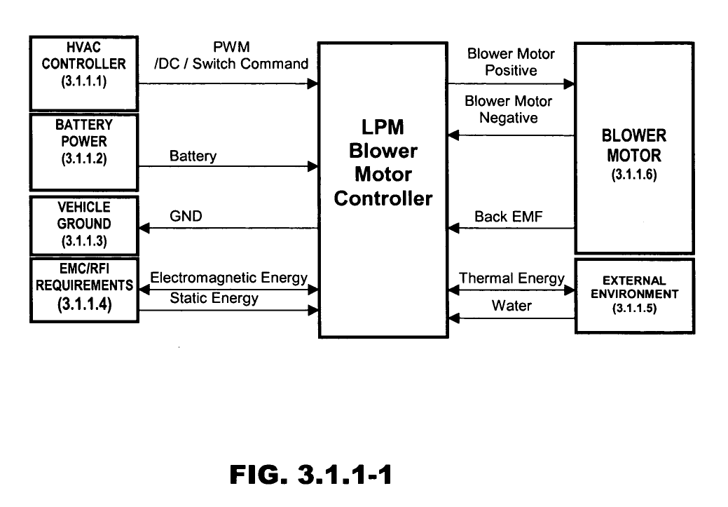

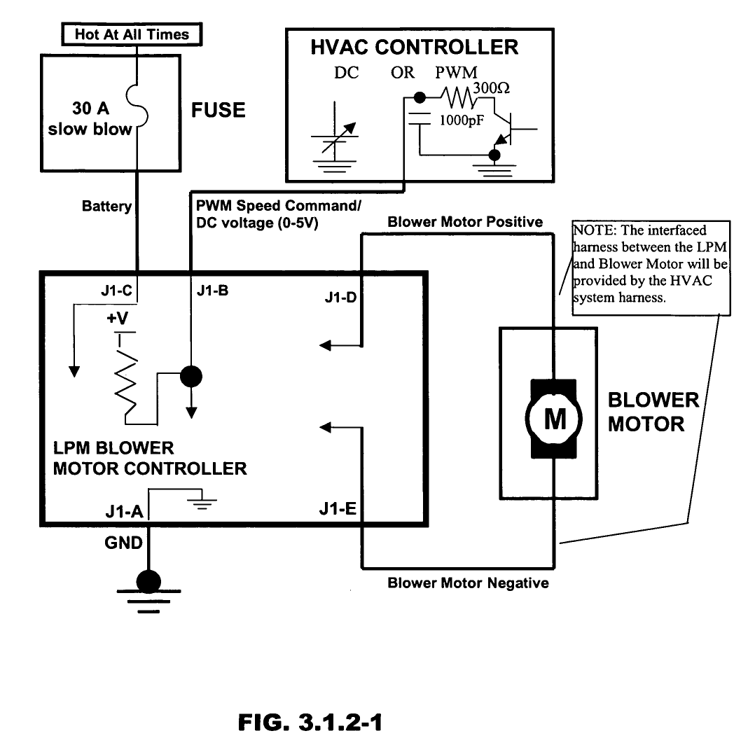

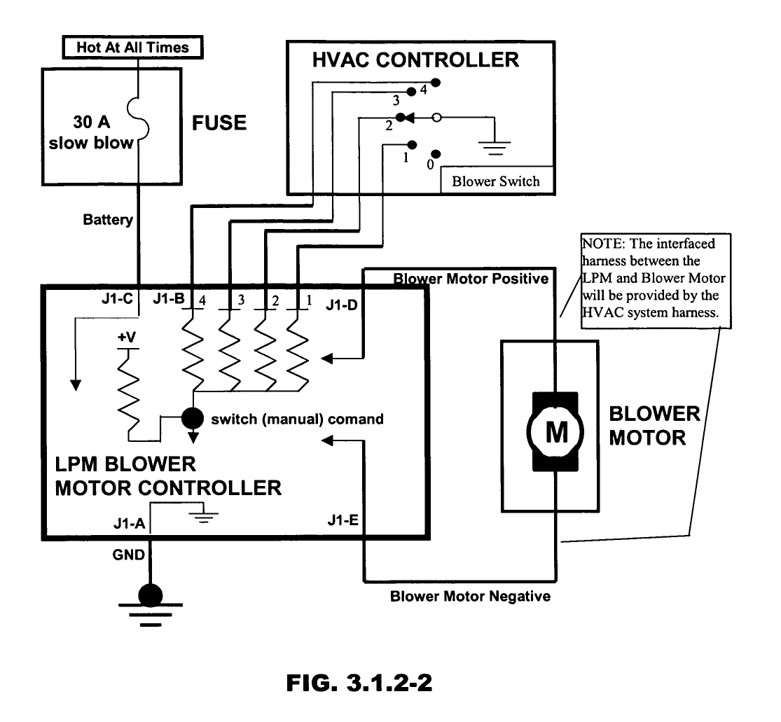

FIG. 3 shows a schematic of an input block 300 of ASIC 220. Input block 300 comprises a PWM/digital block 310, a discrete/digital block 320, a DC/digital block 330, an adder 340, a D/A converter 345, and a slope controller 350.

The function of adder 340 is to add the 8-bit digital signals applied to its inputs.

Slope control block 350 controls the rate of change of the voltage appearing at V_{control}. This is needed to avoid applying rapidly changing voltages to motor 250, which could induce inrush current spikes within the motor circuit.

PWM/digital block 310 converts the input PWM control signal to an 8-bit digital signal. The output signal from PWM/digital block 310 is active when the duty cycle of the input signal is between 5% and 95%.

Discrete/digital block 320 processes the signals from the four positions (A, B, C, and D) of selector switch 260, which correspond to switches 262, 264, 266, and 268. For example, when switch position A is selected by closing switch 262, discrete/digital block 320 produces a first digital output signal. Likewise, when switch position B, C, or D is selected, a second, third, or fourth digital output signal, respectively, is produced. Discrete/digital block 320 is active only when one of switches 262, 264, 266, or 268 is closed, thus grounding one of the corresponding inputs A, E, C, or D to input block 300.

Grounding of switches 262, 264, 266, and 268 (A, B, C, D) corresponds to appropriate DC voltage values 5 V, 3.75 V, 2.5 V, and 1.5 V, respectively. Further, discrete/digital block 320 converts each such voltage to an 8-bit digital value, e.g., 5V is converted to 11111111B, 3.75V to 11000000B, 2.5V to 10000000B, and 1.5V to 01001101B.

Further, although FIG. 3 depicts discrete/digital block 320 with four inputs, the present invention is not limited thereto, and discrete/digital block 320 may have fewer or greater than four inputs. Further, in a case where the number of positions on the selector switch is less than the number of inputs on discrete/digital block 320, some number of the inputs of discrete/digital block 320 may remain unconnected. In such a case, the lowest and highest ranking positions of the inputs of discrete digital block 320 are preferably used for the highest and lowest positions of the selector switch, and the remaining selector switch positions are preferably assigned as evenly as possible across the remaining inputs of discrete/digital block 320.

Discrete/digital block 320 enables system 200 of the present invention to serve as a drop-in replacement for conventional resistor card-based fan speed selectors in automobiles. The design of the circuitry of discrete/digital block 320 is well known in the art, and library modules are commercially available to incorporate such a block in an ASIC.

DC/digital block 330 has two functions: (1) to process the input signal from a control potentiometer, and (2) to generate an offset for transfer function. DC/digital block 330 converts the DC voltage to an 8-bit digital value, e.g., 5V is converted to 1111111B.

When DC/digital block 330 is used to process the input signal from a control potentiometer (not shown), the resistive value of an external potentiometer is measured, and discrete/digital block 320 produces an output digital signal that is proportional (or inversely proportional) to the measured resistance. Thereby, motor 250 can be continuously controlled rather than discretely controlled. Further, DC/digital block 330 produces a digital output only when the U_{DC} is greater than 0.5 V.

When DC/digital block 330 is used to generate a transfer function, it outputs an offset digital signal based on the input signal, and that offset digital signal is combined, by adder 340, with the output from PWM/digital block 310 or the output from discrete/digital block 320. The input signal to DC/digital block 330 is determined by the specifications of the motor 250 to be controlled.

According to the above description, only one of PWM/digital block 310, discrete/digital block 320, and DC/digital block 330 operates at anyone time. However, when DC/digital block 330 operates in offset mode, it operates in combination with either PWM/digital block 310 or discrete/digital block.

PWM/digital block 310 converts a duty cycle of I (high DC value) to an 8-bit digital value of 11111111B, and a duty cycle of 50% to 10000000B.

The output of adder 340 is a digital signal that is converted to an analog signal by D/A converter 345, which is then processed by slope controller 350 so that V_{control} is appropriate for the particular motor 250 to be controlled.

Thereby, linear controller 210 is provided with multiple interfaces.

In an alternative embodiment, those skilled in the art will appreciate that the multiple interfaces of linear controller 210 of the present invention may be implemented using well-known discrete electronic devices rather than being integrated within an ASIC, such as ASIC 220.

### EXAMPLES

The following examples are not intended to limit the scope of the invention, but merely to illustrate representative possibilities concerning the present invention.

### Example 1

### A Specification of an LPM Blower Motor Controller of the Invention

1.1 Scope of Document

This specification establishes functional performance, design, test, manufacture, and acceptance requirements for the Linear Power Modulation (LPM) Blower Motor Controller which is typically a sub-component of an automotive Heating Ventilation and Air Conditioning (HVAC) Module. Supporting documentation tailored for the specific application shall be provided by the customer.

1.2 Component Purpose

The LPM Blower Motor Controller shall provide variable speed control of the HVAC Brushed Blower Motor in such a manner that the controller power dissipation is minimized at high speed.

2.1 Compliance

The following list may be used as a general guideline to determine various performance requirements of the LPM. Customer-specific requirements shall supercede these requirements.

| | |
|---|---|
| General Specification for Electrical/Electronic | GMW3100GS |
| Component Subsystems Electromagnetic | GMW 3097GS |
| Compatibility | |
| Conducted Transient Emissions and Immunity | GMW3097GS |
| (CE/CI) | Paragraph 3.2.1.3.2 |
| Bulk Current Injection | GMW3097GS |
| | Paragraph 3.2.1.2.2 |
| Radiated Emissions, Component Tests | GMW3097GS |
| | Paragraph 3.2.1.1.1 |
| | Paragraph 3.2.1.1.2 |
| Conducted Emissions, Test with the Artificial | GMW3097GS |
| Network | Paragraph 3.2.1.1.3 |
| CI, Jump Start and Reverse Polarity | GMW3097GS |
| | Paragraph 3.2.1.3.4 |
| ESD, Sensitivity Classification for Packaging | GMW3097GS |
| and Handling | Paragraph 3.2.1.4.3 |
| Radiated Immunity, Component Tests | GMW3097GS |
| | Paragraph 3.2.1.2.1 |
| Salt Spray (Mist) Test Procedure | GM9298P |
| Packaging and Identification Requirements for | GM1738 |
| Production Parts | |
| Restricted and Reportable Chemicals | GMI000M |
| Standard Practice for Designating Plastic Materials | SAE J1344 |
| and Marking Plastic Parts | |

3. Requirements
3.1 Component Definition
3.1.1 External Interface Description

FIG. 3.1.1-1 shows a block diagram of the context of the LPM Blower Motor Controller prepared according to the invention.

3.1.1.1 HVAC Controller

The HVAC Controller shall provide an open collector PWM Speed, DC voltage, or Switch Command output to the LPM Controller. The PWM Speed Command is a Pulse Width Modulated signal that requests the blower motor operating voltage and mode.

3.1.1.2 Battery Power

The Battery shall directly power the LPM Controller; thus it is powered when Ignition is off.

3.1.1.3 Vehicle Ground

The LPM Controller shall be directly connected to vehicle ground.

3.1.1.4 EMC/RFI Description

The LPM Controller, blower motor, and other electronic and electro-mechanical devices in a motor vehicle produce electromagnetic emissions as a by-product of their operation. The LPM Controller shall operate in this electromagnetic environment and not adversely affect operation of other electronic devices in the vehicle. Specific component EMC tests referenced in this specification shall be conducted at the bench-top level with a representative blower motor as the load. Passing the component level tests does not guarantee that the full-vehicle EMC requirements will be met.

3.1.1.5 External Environment

Thermal Energy generated by the LPM Controller shall be dissipated to the External Environment. The External Environment may provide Thermal Energy to the LPM Controller (refer to Section 3.1.4 for Environmental Conditions). Water and water-based fluids may come in contact with the heat sink of the LPM Controller when the heat sink requires HVAC module airflow for cooling.

3.1.1.6 Blower Motor

The HVAC Blower Motor is a permanent magnet, brush-type fractional horsepower DC Motor.

3.1.2 External Interface Definition

A) PWM or DC Speed Control

FIG. 3.1.2-1 shows a schematic of an LPM motor controller electrical interface definition for PWM or DC control for an LPM controller prepared according to the invention.

B) Switch (Manual) Control

FIG. 3.1.2-2 shows a schematic of an LPM motor controller electrical interface definition for switch (manual) control for an LPM controller prepared according to the invention.

3.1.2.1 Battery Power and Vehicle Ground

Fused Battery Power shall be supplied to the LPM Controller. The fuse shall typically be a 30 Ampere Maxifuse for the Standard Power Rating LPM Controller (25 A maximum rated current). The LPM Controller shall be electrically connected to vehicle ground through an unfused wire. The combined impedance of Battery Power and Vehicle Ground shall be less than 70 m Ohms.

3.1.2.1.1. Battery Power

| Pin | Terminal Name | Function |
|---|---|---|
| J1-C | Battery | LPM Controller Power |

| Condition | Rating |
|---|---|
| Minimum Voltage | 8 V |
| Maximum Voltage | 16 V |
| Maximum Quiescent Current | <5 mA |
| Maximum Power Consumption | 85 W |
| by LPM Controller only @ worst case speed | |
| Maximum Power Consumption by LPM | 18 W |
| Controller only @ full speed | |
| Maximum Current @ 16 Volts Battery | 25 A |

3.1.2.1.2. Vehicle Ground

| Pin | Terminal Name | Function |
|---|---|---|
| J1-A | GND | LPM Controller Ground |

| Condition | Rating |
|---|---|
| Maximum Current @ 16 Volts Battery | 25 A |

3.1.2.2PWM/DC Speed Command

| Pin | Terminal Name | Function |
|---|---|---|
| J1-B | PWM/DC | Requests Blower Motor operating |
| | Speed Command | voltage and modes |

| Condition | Rating |
|---|---|
| Type: PWM | Open Collector Compatible Input |
| Minimum Input Frequency | 20 Hz |
| Maximum Input Frequency | 1 kHz |
| Minimum “Low” Source Current | 2 mA |
| Resolution | 1% Duty Cycle |
| Type: DC | 0-5 V Analog Input |
| Minimum Current in the Active state | 0.05 mA |
| Maximum Current in the Active state | 0.5 mA |
| Load Resistance R1 | 10 kOhm |
| Resolution | Continuous Signal |
| Type: Switch | B1, 2, 3, 4 LPM input switch to |
| | ground |
| Minimum Current in the Active state | 0.1 mA |
| Maximum Current in the Active state | 2 mA |
| Load Resistance R1 | 5 kOhm |
| Resolution | 25% or four adjustable steps |

3.1.2.3 Blower Motor Outputs

Specific Blower Motor specifications lie outside the scope of this document, however, the suppression circuit details contained in the Blower Motor shall be supplied. The LPM Controller, without any degradation in performance, shall be able to drive a blower motor noise suppression capacitor of up to 0.47° F.

3.1.2.3.1. Blower Motor Positive

| Pin | Terminal Name | Function |
|---|---|---|
| J1-D | Blower Motor Positive | Provides Power to the Positive Terminal |
| | | of the Blower Motor |

| Condition | Rating |
|---|---|
| Maximum continuous Current @ 65° C. | 25 A |
| Average Maximum Voltage | 16 V |
| Maximum Stall Current Surge | 40 A < 1 s |
| Maximum Stall Current Duration | Indefinite |

3.1.2.3.2Blower Motor Negative

| Pin | Terminal Name | Function |
|---|---|---|
| J1-E | Blower Motor | Provides Ground to the Negative Terminal on the |
| | Negative | Blower Motor |

| Condition | Rating |
|---|---|
| Maximum continuous Current @ 65° C. | 25 A |
| Average Maximum Voltage | 16 V |
| Maximum Stall Current Surge | 40 A < 1 s |
| Maximum Stall Current Duration | Indefinite |

3.1.2.4 Input/Output Connector Customer Specific
3.1.2.5 Output Connector

An output connector to mate with the blower motor will not be required, and will be provided by the HVAC system harness.

3.1.3 Component Diagrams

3.1.3.1 Block Diagram—TBD

3.1.3.2 Schematic Diagram

The Schematic Diagrams are shown in various Figures according to the invention.

3.1.4Environmental Conditions

| | Rating |
|---|---|
| Item | Heat Sink In Air Flow |
| Static Operating Temperature Range | −40° C. to +65° C. |
| Maximum Surface Temperature at | 65° C. |
| 38° C. Ambient | |
| Transient Operating Temperature | 85° C. to 65° C. (In less than 5 |
| | minutes for Heat Sink only) |
| Storage Temperature Range | −40° C. to +105° C. |
| Relative Humidity | 0% to 95% Non-Condensing |
| Air Flow | HVAC Specific |

3.1.5 Usage Definition TBD
3.2 Product Characteristics
3.2.1 Functional Performance Requirements

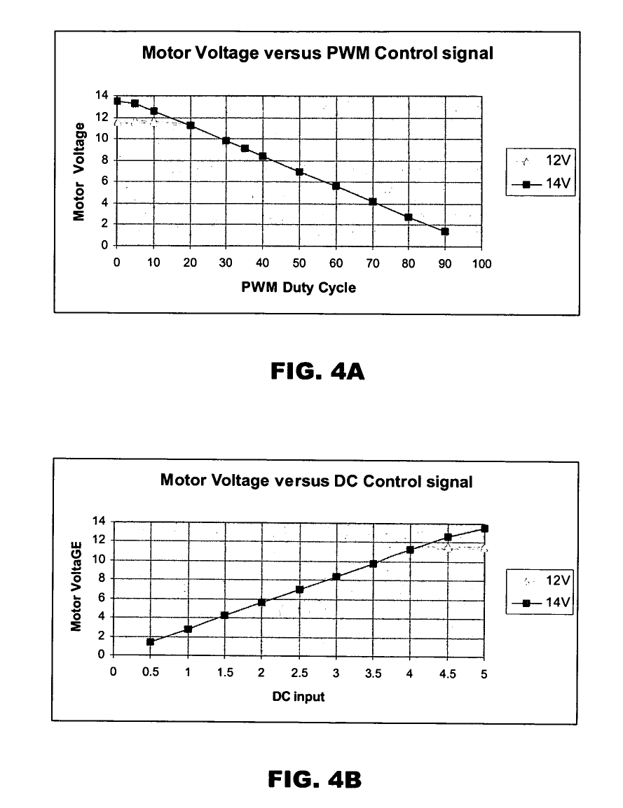

The function performance of the LPM Controller shall meet the requirements of the Typical LPM Blower Motor Controller Transfer Function (FIG. 4A), LPM Blower Motor Controller Mode Designation (FIG. 4B), and LPM Blower Motor Controller State Transition Diagram.

3.2.1.1 Typical LPM Blower Motor Controller Transfer Function

The LPM Controller provides a typical transfer function as shown in FIG. 4a and mode designation as shown in FIG. 4b. The Average Motor Voltage is obtained by either the DC voltage level applied to the Blower Motor or an average of a LPM voltage applied to the Blower Motor over a period of time. If the Battery voltage is changed by ±1.0 Volt, a less than or equal to ±0.1 Volt change in the Blower Motor voltage shall result unless saturation occurs due to Battery voltage (implied by transfer function).

FIGS. 4a and 4b related to typical LPM Blower Motor Controller Transfer Functions are attached hereto.

3.2.1.2.2 Run Mode

The Typical LPM Blower Motor Controller Transfer Function of FIG. 4 is executed while in Run mode providing that the PWM Speed Command duty cycle remains greater than or equal to 10% (or 0.5V DC). The LPM Controller shall enter a sleep mode if the PWM Speed Command duty cycle is less than 10% (or 0.5V DC).

3.2.1.2.3 Fault Mode

3.2.1.2.3.1 Blower Motor Lock Rotor

Option A: LPM will fail safe. It will not cause any smoke or fire.

Option B: LPM will shut down and restart after 1-2 sec.

3.2.1.2.3.2 Battery Over Voltage

3.2.1.2.3.3 Battery Under Voltage

3.2.1.3 Average Motor Voltage Response Time

The Average Motor Voltage Ramp Rate shall be approximately ±10 Volts per Second.

3.2.1.4 EMC/RFI

The LPM Controller and Blower Motor shall successfully complete EMC/RFI tests as referenced in “compliances” or as required by The Customer. These requirements shall be specified in detain in the LPM Blower Motor Controller Verification Test Plan.

3.2.1.5 Controller Saturation Voltage

The maximum saturation voltage of the LPM Controller shall be <0.7 Volts at the controller rated output current.

3.2.1.6 Efficiency

N/A

3.2.1.7 Quiescent Current and Leakage Current

The LPM Controller shall meet the requirements of Table 3.2.1.7-1 while in Sleep Mode.

TABLE 3.2.1.7-1

| Condition | Rating |
|---|---|
| Quiescent Current | ≦5 mA @ 25° C. |
| Leakage Current Through Blower Motor Brushes | ≦100 μA @ 85° C. |

3.2.1.8 PWM Speed Command Ground Offset

The LPM Controller shall operate within specifications with a ±2 Volt ground offset between the HVAC Controller and LPM Controller on the PWM Speed Command input.

3.2.1.9 Surface Temperature

Any exposed surfaces of the LPM Controller shall not exceed 65° C. surface temperature at an ambient temperature of 38° C. under all operating conditions.

3.2.1.10 Isolation

All external surfaces of the LPM Controller shall be electrically isolated or grounded.

3.2.1.11 Water Intrusion

The LPM Controller shall continue to operate as designed when the heat sink is exposed to fluids. For Fluid Compatibility/Damageability GMN3172 section 4.3.5.1.1 should be followed. A gasket shall be provided on the heat sink to prevent water and water based fluids from entering the vehicle passenger compartment when the heat sink is in the HVAC module airflow.

3.2.1.12 Audible Noise

The LPM Controller shall not create any audible noise or cause any audible noise from the Blower Motor or the HVAC module.

3.2.1.13 Shock

Refer to the LPM Blower Motor Controller Verification Test Plan.

3.2.1.14 Vibration

Refer to the LPM Blower Motor Controller Verification Test Plan.

3.2.2 Physical Packaging Characteristics

3.2.2.1 Size

The size of the LPM is customer specific.

3.2.2.2 Mass

The mass of the LPM Controller shall be minimized. The mass shall be less than 250 grams (less than 100 grams for evaporator mounted design).

3.2.2.3 Drawing N/A

3.2.3 Reliability and Durability

3.2.3.1 Reliability

The LPM Controller shall have a reliability of 98% at 50% confidence interval and shall have a reliability of 1.000 as delivered.

3.2.3.2 Durability

The target life of the LPM Controller shall be 10 years and/or 100,000 miles and/or at least 5300 hours of operation.

3.2.4 Maintenance, Service, and Repair

The LPM Controller shall not require any scheduled maintenance and is not repairable. The LPM Controller shall be removed and replaced should any repair be required.

3.3 Design and Construction

3.3.1 Material, Processes, and Parts Selection Guideline

Where available, automotive grade materials and components shall be used. Plastic materials shall be selected with sufficient mechanical strength, high temperature resistance and environmental durability.

3.3.2 Design Guidelines

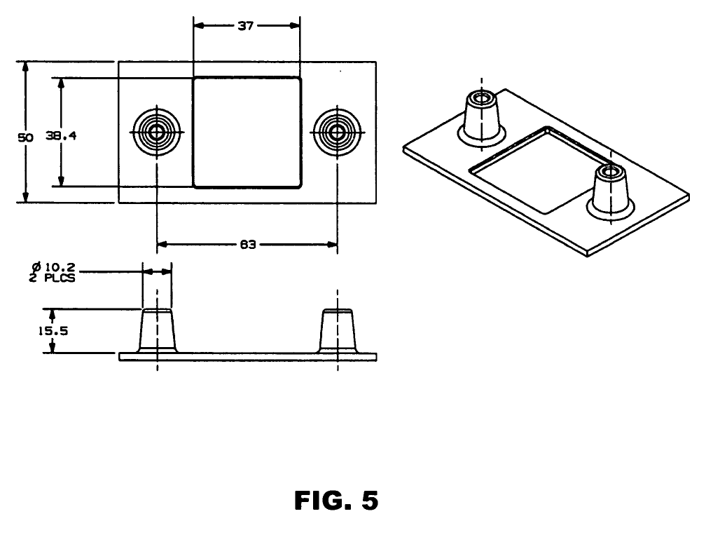

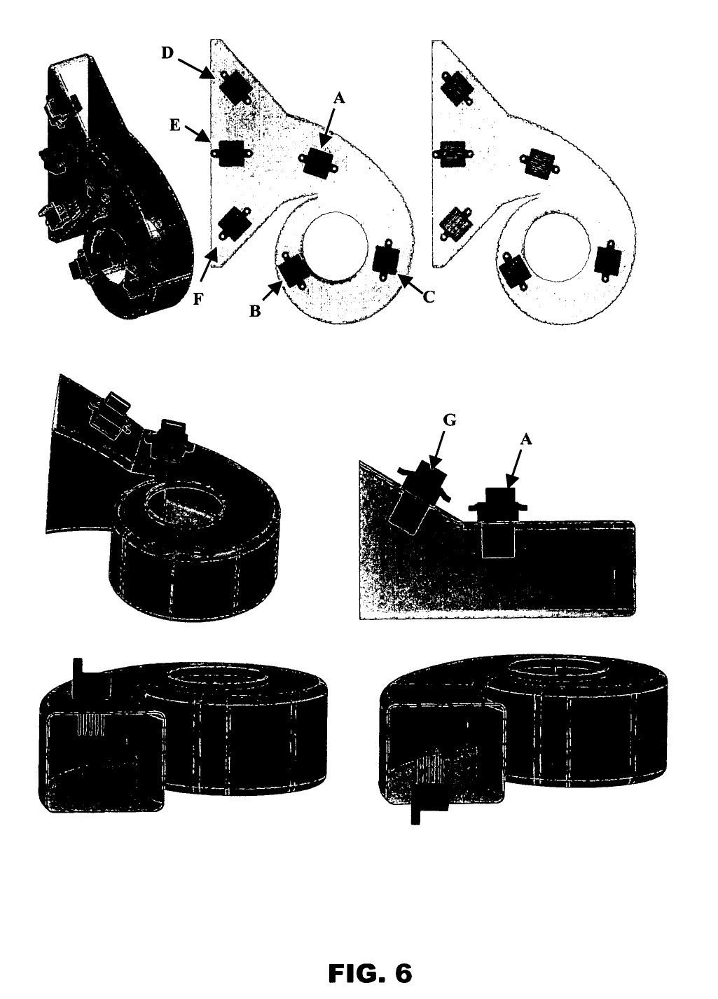

Mounting Footprint—The LPM Controller shall have a standard mounting footprint and orientation as outlined in the attached FIGS. 5 and 6.

Mounting Considerations—The LPM Controller shall be mounted such that the heatsink fins are parallel to the airflow vector. The LPM Controller shall be mounted at the outlet of the HVAC blower scroll (position A). The LPM shall not be placed within blower scroll region, which will impede airflow development (positions B & C). The LPM shall not be mounted at immediately upstream or downstream from heat exchangers or in regions where sudden expansion of the HVAC housing (airflow) occur; areas of low airflow (positions D, E, F & G)

The LPM Controller shall be mounted on the upper surfaces of HVAC housings, such that the heatsink always points downwards. The LPM shall not be mounted upside down on the underside of an HVAC module in the in-car position.

3.3.2.1 Recycling Guidelines

Where design requirements permit specifying a material, a recyclable material shall be selected.

3.3.3 Identification and Marking

Identification and marking of LPM's shall be determined by the customer.

3.3.3.1 Plastic Components

Plastic Components shall be marked with plastic material and recycle symbols in accordance with SAE J1344.

3.3.4 Workmanship

3.3.4.1 Defects

The product shall be free of any defects, damage, or foreign material that could affect function or appearance or lead to malfunctions.

3.3.4.2 Contaminants

Parts and surfaces shall be free of contaminants including dirt, oil, flux, or other process fluids or materials.

5. Shipping and Packaging

Unless otherwise agreed to, packaging shall be developed to meet the GM 1738 (GM Packaging and Identification Requirements for Production Parts) standard.

8.2 Acronyms, Abbreviations, and Symbols

TABLE 8.2-1

| Acronym | Definition |
|---|---|
| A | Amperes |
| A/C | Air Conditioning |
| BCI | Bulk Current Injection |
| Mm | Millimeters |
| CFM | Cubic Feet Per Minute |
| DC | Direct Current |
| EMC | Electromagnetic Compatibility |
| EMF | Electromotive Force |
| ESD | Electrostatic Discharge |
| GND | Vehicle Ground |
| HVAC | Heating, Ventilation and Air Conditioning |
| I_{MOTOR} | Blower Motor Current |
| LPM | Linear Power Module |
| Hz | Hertz (cycles per second) |
| KHz | Kilohertz (cycles per second) |
| MA | Milliamperes |
| MHz | Megahertz |
| MΩ | Megohm |
| PWM | Pulse Width Modulation |
| RFI | Radio Frequency Interference |
| TBD | To Be Determined |
| TPM | Temperature Power Module |
| V | Volt |
| V_{BATTERY} | Battery voltage |
| W | Watt |
| ° C. | Degrees Celsius |
| Ω | Ohm |
| μA | Microamperes |
| PF | Picofarads |
| ± | Plus or Minus |
| ≦ | Less Than or Equal To |
| ≧ | Greater Than or Equal to |
| < | Less Than |
| > | Greater Than |
| % | Percent |

Although preferred embodiments of the invention have been described in the foregoing description, it will be understood that the invention is not limited to the specific embodiments disclosed herein but is capable of numerous modifications by one of ordinary skill in the art. It will be understood that the materials used and the electrical or mechanical details may be slightly different or modified from the descriptions herein without departing from the methods and compositions disclosed and taught by the present invention.

1-2. (canceled)

3. A linear electric motor controller comprising:
a first input circuitry that receives signals configured and adapted to control pulse width modulation;
a second input circuitry that receives signals configured and adapted to control discrete step-wise output;
a third input circuitry that receives signals configured and adapted to provide continuous variable control; and
controller circuitry operatively coupled to the first, second, and third input circuitry for varying output signals applied to a controlled device.

4. The linear electric motor controller of claim 3, wherein the controller is in a closed loop feedback arrangement with the controlled device.

5. The linear electric motor controller of claim 3, wherein the controller comprises a MOSFET that is responsive to the third input circuitry.

6. The linear electric motor controller of claim 3, wherein the controller is part of an ASIC.

7. A method of controlling a vehicle heating, ventilating, and air conditioning system which comprises:
controlling pulse width modulation of the system;
providing discrete step wise control to the system; and
providing continuous variable control to the system.

8. The method of claim 7, which further comprises implementing a closed loop feedback arrangement with a controlled device.

9. The method of claim 7, which further comprises implementing a MOSFET that is responsive to a voltage across a controlled device configured and adapted to provide continuous variable control.

10. The method of claim 7, which further comprises providing an ASIC configured and adapted to control pulse width modulation, to provide discrete step-wise control; and to provide continuous variable control.
